(19) United States
(12) Patent Application Publication
(10) Pub. No.: US 2026/0367786 A1
(43) Pub. Date: Nov. 19, 2026

(54) INTEGRATED MEMORY MANAGEMENT METHOD AND SYSTEM BASED ON DEEP LEARNING TRAINING

(71) Applicant: HUAZHONG UNIVERSITY OF SCIENCE AND TECHNOLOGY, Wuhan (CN)

(72) Inventors: Xuanhua SHI, Wuhan (CN); Hai JIN, Wuhan (CN); Yuhao LI, Wuhan (CN); Yusheng HUA, Wuhan (CN); Yunfei ZHAO, Wuhan (CN)

(21) Appl. No.: 19/676,303

(22) Filed: May 13, 2026

(30) Foreign Application Priority Data
May 15, 2025 (CN) 2025106280428
Apr. 9, 2026 (CN) 2026104598159

(51) Int. Cl. G06F 3/06

(52) U.S. Cl. CPC G06F 3/0604; G06F 3/064; G06F 3/0679

(57) ABSTRACT

An integrated memory management method and system based on deep learning training are provided. The method includes: partitioning a dataset to form a plurality of chunks; grouping the chunks to form chunk groups, and mapping chunks within the same chunk group to the same abstract chunk, such that a plurality of abstract chunks constitute a logical abstract memory space; determining an abstract memory slot corresponding to a requested data file in response to a data access request; in response to determining that the abstract memory slot is empty or invalid, selecting, from an associated chunk group based on respective fill rates of the chunks, a target chunk for reloading, and filling empty slots in the abstract chunk with the reloaded data; and marking an actually consumed data file as invalid. The present disclosure utilizes random access characteristics to significantly improve training data loading efficiency and system I/O throughput capabilities.

### BACKGROUND OF THE APPLICATION

### 1. Technical Field

The present disclosure generally relates to the field of artificial intelligence training technology, and in particular, to an integrated memory management method and system based on deep learning training.

### 2. Description of Related Art

Deep learning has penetrated into various fields, comprising computer vision, speech recognition, and natural language processing, becoming ubiquitous in society. The widespread adoption of deep learning is largely attributed to its outstanding accuracy. Such quality depends not only on deep neural network algorithms, but also on training datasets. High-quality, diverse, and massive datasets are keys to achieving high accuracy for a deep neural network model. Therefore, a dataset utilized to train the deep neural network model is becoming increasingly larger, which can reach a terabyte (TB) level and comprise tens of millions of data instances. Such a massive dataset will bring enormous I/O pressure to deep learning training. In particular, significant progress in high-performance computing accelerators (such as GPUs and TPUs) further widens a gap between a speed of processing training data and a speed of fetching data from a disk, making an importance of an I/O performance bottleneck more prominent.

Addressing the I/O bottleneck in deep learning training faces two challenges. A first challenge is massive and continuously growing training data. A huge gap between a processing speed of computing units, such as a CPU and a GPU, and I/O performance is well known. An existing method to narrow the gap is to utilize a basic principle of a memory hierarchy: utilizing memory as a layer between I/O and the computing units. However, a massive scale of the training data is crucial for achieving high model accuracy, which only allows the memory to retain a small portion of data.

An intelligent memory management mechanism can typically achieve efficient data caching; however, such a capability is hindered by a second challenge: an access pattern of deep learning training data is highly randomized. This renders various replacement strategies, such as Least Recently Used (LRU) or Least Frequently Used (LFU), which are aimed at capturing certain access patterns, obsolete. Deep learning training performs random iteration on a training dataset in each epoch, and such randomness is necessary to guarantee training efficiency.

Due to a highly randomized access pattern of deep learning training data, design and optimization space for its memory management is very limited. Without compromising randomness, most existing methods cache a fixed portion of data in a memory, enabling cached data to be accessed faster, while still incurring high latency for uncached data via I/O. Based on such a static caching strategy, a proportion of data access capable of being accelerated is entirely dependent on a memory capacity. Unfortunately, the memory capacity cannot scale with an increase in data volume. In addition, input data for deep learning training is typically stored in a plurality of small data files. When randomly accessed, the plurality of small data files incurs higher I/O overhead compared to large data files. To minimize the overhead, large-scale analysis systems typically reorganize the small data files into relatively large chunks, and adopt batch reading. However, due to the highly randomized access pattern, directly applying batch reading to deep learning training is not effective. Specifically, when a chunk is loaded from external storage, there is no way to ensure that all or most of data contained in the chunk is utilized by a deep learning framework before being swapped out of the memory.

For example, Chinese Patent Application Publication No. CN119025281A discloses a method and device for allocating memory resources, a storage medium, and an electronic device. The method comprises: allocating a first memory management algorithm for a memory invocation request sent by a deep learning framework, wherein the memory invocation request is configured to request to invoke a target memory for a training task, and the memory invocation request carries at least memory type information of the target memory and memory size information of a first memory resource; determining, based on the memory type information, a first basic interface group pre-configured for the target memory, wherein a device comprising the deep learning framework is deployed with memories of at least two memory types, the at least two memories comprise the target memory, wherein the first basic interface group is an encapsulated interface group for a proprietary interface of the target memory, and the encapsulated interface group is allowed to be invoked by any memory management algorithm; and invoking the first basic interface group via the first memory management algorithm, so as to allocate the first memory resource having a memory size indicated by the memory size information for the training task. However, a core of this technical solution lies in implementing flexible invocation of a memory management algorithm via interface encapsulation, and optimizing resource allocation for different memory types. However, its technical logic still relies on a basic assumption of an existing memory hierarchy, i.e., reducing I/O access by caching a portion of data. When a scale of training data exceeds the memory capacity (e.g., a currently common PB-level training dataset), even if an intelligent allocation strategy is adopted, a physical memory still cannot cover a sufficient data volume. The patent does not propose an innovative mechanism to dynamically expand memory capacity or break through limitations of a memory-storage hierarchy, resulting in its optimization effect being limited to local resource allocation, and failing to resolve a fundamental contradiction of an order-of-magnitude difference between the memory capacity and the data scale.

Chinese Patent Application Publication No. CN116501696A discloses a method and device for prefetch cache management applicable to distributed deep learning training, comprising: initializing a prefetch cache space when a deep learning task is initialized; generating a shuffling sequence for an epoch before training of each epoch of the deep learning task starts, and constructing a cache index according to the shuffling sequence; obtaining data from the prefetch cache space according to the cache index during training of the deep learning task; if a cache miss occurs, performing batch prefetching from a distributed storage taking a storage node as a partitioning basis; and initiating cache eviction when a used capacity of the prefetch cache space reaches a specified threshold, and evicting data with a cache hit. The method and device perform batch prefetching based on the storage node, which reduces the number of communications between nodes and improves communication efficiency; meanwhile, by evicting the data with the cache hit, the cache only contains data about to be hit, thereby improving a cache hit rate. This technical solution only discloses a simple prefetch linked list eviction mechanism, and suffers from an objective defect of failing to solve a problem of local invalidation when variable-length data is loaded at a chunk level.

Therefore, a technical problem of how to significantly improve an efficiency of deep learning training data access remains unresolved.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

To address the defects of the existing art, an objective of the present disclosure is to solve a technical problem that I/O becomes a performance bottleneck for deep learning training when a memory capacity is insufficient to cache a training dataset in a memory.

To address the above problems, a first aspect of the present disclosure provides an integrated memory management method based on deep learning training, executed by a computing device configured with a storage device and a hardware accelerator. The method comprises the following steps: performing a partitioning operation on a dataset stored in the storage device to form a plurality of chunks; grouping the plurality of chunks to form a plurality of chunk groups, and establishing a mapping structure between a physical memory and the storage device to map chunks within the same chunk group to the same abstract chunk, such that a plurality of abstract chunks constitute a logical abstract memory space; in response to receiving a data access request, determining an abstract memory slot corresponding to a requested data file; in response to determining that the abstract memory slot is empty or invalid, selecting, from an associated chunk group based on respective fill rates of the chunks, a target chunk for reloading, and transmitting reloaded data from the storage device and filling empty slots in the abstract chunk in the physical memory with the reloaded data; and clearing a mapping relationship of an actually consumed data file in a mapping table to mark the actually consumed data file as invalid, and releasing a memory space occupied by the actually consumed data file.

The technical solution fully utilizes a characteristic of data access having no fixed order during a deep learning training process. It avoids a problem of existing cache replacement strategies failing in random access scenarios, thereby significantly improving loading efficiency of training data and system I/O throughput capabilities.

According to a preferred embodiment, the step of performing the partitioning operation on the dataset comprises: performing a random shuffling operation on a complete dataset to generate a randomized data index sequence; and performing a partitioning operation on the randomized data index sequence based on a set chunk size to form a plurality of fixed-size chunks, wherein each chunk comprises a plurality of data files.

Through the shuffling operation, the technical solution ensures that a training data access process possesses sufficient randomness semantics. Fixed-size chunking provides a basic carrier for subsequent batch data loading, thereby improving single I/O efficiency.

According to a preferred embodiment, prior to grouping the plurality of chunks to form the plurality of chunk groups, the method further comprises: determining the number of abstract memory slots in the abstract memory space based on a memory capacity in units of bytes and an average size of data files in the dataset; and determining a size of the chunk group based on a total number of data files in the dataset and the number of abstract memory slots.

The technical solution is capable of dynamically adapting according to an actual memory capacity in units of bytes. Such a logical design established on top of physical memory resources is intended to mask the underlying physical distribution through logical mapping, thereby supporting efficient random access and reuse.

According to a preferred embodiment, after determining the abstract memory slot corresponding to the requested data file, the method further comprises: in response to determining that a data file pointed to by the abstract memory slot is currently valid data, directly returning a corresponding data file index.

For a data file that is currently filled into an abstract memory slot and has not yet been actually consumed by a deep learning training task (i.e., valid data), the system can skip a cumbersome disk reloading process, and respond to the data access request with the shortest path and the fastest speed, so as to reduce access latency to the maximum extent.

According to a preferred embodiment, the step of selecting, from the associated chunk group based on the respective fill rates of the chunks, the target chunk for reloading comprises: calculating respective fill rates of a plurality of candidate chunks in the associated chunk group; and determining the candidate chunk having the highest fill rate among the plurality of candidate chunks as the target chunk for reloading.

The technical solution is capable of dynamically determining an optimal chunk loading path. This ensures that data files loaded within the chunk are maximally consumed by the training task, thereby greatly reducing invalid data loading and redundant memory storage without compromising random access characteristics of the data.

According to a preferred embodiment, in a distributed scenario comprising a plurality of participating nodes, the computing device is a requesting node in a distributed cluster comprising the plurality of participating nodes, and the method further comprises: processing a remote data request based on an opportunistic prefetching mechanism; wherein a globally randomized and fixed data access sequence is generated for each participating node; when the participating node, acting as the requesting node, initiates an access request to another participating node acting as an owner node of a target data file, appending a current position index in a local access sequence of the participating node to the access request; and receiving data files sent from the owner node, wherein the received data files further include data files within a prefetch window inferred by the owner node based on the current position index.

According to a preferred embodiment, in the distributed scenario comprising a plurality of participating nodes, the computing device is the requesting node in the distributed cluster comprising the plurality of participating nodes, and the method further comprises: inferring, by the owner node, the prefetch window based on the current position index appended by the requesting node, and sending the data files within the prefetch window to the requesting node in advance when a target slot of the owner node has data and a corresponding abstract memory slot of the requesting node is empty.

The technical solution effectively reduces cross-node communication bandwidth overhead and remote I/O access latency. Such a mechanism is particularly suitable for a distributed deep learning training scenario where a training data volume far exceeds a memory capacity of a single node.

According to a preferred embodiment, mapping chunks within the same chunk group to the same abstract chunk comprises: enabling each abstract chunk to maintain a starting address of the mapped chunk and an address offset range of each data file in the chunk, so as to support random access to variable-length data files.

The technical solution successfully supports random access to the variable-length data files. Since the sizes of data files within a chunk vary, maintaining the address offset range completely solves a problem of precise positioning of heterogeneous file sizes under chunk-level management.

According to a preferred embodiment, the method further comprises: when the requesting node receives the data files sent from the owner node, processing the data files in order of priority, wherein an on-demand response takes priority, followed by prefetched data; and in response to determining that an abstract memory slot mapped by the prefetched data is currently occupied or contains valid data, discarding, by the requesting node, the prefetched data.

Such a priority classification and conflict resolution mechanism ensures that prefetched data can be successfully received and cached. Discarding prefetched data that will cause a conflict in a timely manner can strictly guarantee memory consistency and training accuracy.

A second aspect of the present disclosure provides an integrated memory management system based on deep learning training, comprising a preprocessing unit, a mapping unit, and a selection unit. The preprocessing unit is configured to perform a partitioning operation on a dataset to form a plurality of chunks. The mapping unit is configured to group the plurality of chunks to form a plurality of chunk groups, and map chunks within the same chunk group to the same abstract chunk, such that a plurality of abstract chunks constitute a logical abstract memory space. The selection unit is configured to determine an abstract memory slot corresponding to a requested data file in response to receiving a data access request; in response to determining that the abstract memory slot is empty or invalid, select, from an associated chunk group, a chunk having a highest fill rate for reloading, and fill empty slots in the abstract chunk with the reloaded data; and mark an actually consumed data file as invalid and release, from the abstract memory space, an abstract memory slot occupied by the actually consumed data file.

On the premise of maintaining fully random access semantics of training data, the system implements chunk-granularity batch data loading and memory reuse. Through efficient cooperation of various units in the system, I/O scheduling performance in a large-scale deep learning training task is fundamentally optimized.

According to a preferred embodiment, the system further comprises a network interface component and a prefetch check component. The network interface component is configured to communicatively connect with a plurality of external computing nodes in a distributed training scenario to construct a logically consistent global abstract memory view. The prefetch check component is connected to the network interface component and the selection unit, and is configured to maintain a globally randomized and fixed access trajectory and execute an opportunistic prefetching decision based on a current access position index and a prefetch window; wherein when receiving an access request, the prefetch check component predicts future access items based on the prefetch window, generates a remote data scheduling command only when a target slot of an owner node has data and a corresponding abstract memory slot of a requesting node is in an idle state, and sends the remote data scheduling command to the selection unit to execute cross-node data exchange.

The present disclosure constructs a logically consistent global abstract chunk address space, and performs refined control on memory access between nodes based on an ownership allocation strategy. This optimizes cross-node I/O performance without compromising randomness, thereby ultimately implementing dual improvements in memory efficiency and training performance.

According to a preferred embodiment, the preprocessing unit is configured to: perform a random shuffling operation on a complete dataset to generate a randomized data index sequence; and perform a partitioning operation on the randomized data index sequence based on a set chunk size to form a plurality of fixed-size chunks, wherein each chunk comprises a plurality of data files.

According to a preferred embodiment, the mapping unit is configured to: determine the number of abstract memory slots in the abstract memory space based on a memory capacity in units of bytes and an average size of data files in the dataset; and determine a size of the chunk group based on a total number of data files in the dataset and the number of abstract memory slots.

According to a preferred embodiment, when mapping chunks within the same chunk group to the same abstract chunk, the mapping unit is configured to: enable each abstract chunk to maintain a starting address of the mapped chunk and an address offset range of each data file in the chunk, so as to support random access to variable-length data files.

According to a preferred embodiment, the selection unit is configured to: after determining the abstract memory slot corresponding to the requested data file, directly return a corresponding data file index in response to determining that a data file pointed to by the abstract memory slot is currently valid data.

According to a preferred embodiment, when calculating a fill rate, the selection unit is configured to: define, as a fillable number, the number of data files that can be filled into corresponding idle abstract memory slots after a candidate chunk is reloaded; and define the fill rate as a ratio of the fillable number to a size of the candidate chunk.

According to a preferred embodiment, the network interface component is configured to: obtain cross-node communication data and ownership information from a plurality of computing nodes; and perform a logical consistency view construction on the cross-node communication data and the ownership information to obtain the logically consistent global abstract memory view.

According to a preferred embodiment, when the requesting node receives data files sent from the owner node, the requesting node performs a receiving response for a data file serving as on-demand response data; and for prefetched data included therein, in response to determining that an abstract memory slot mapped by the prefetched data is currently occupied or contains valid data, the requesting node discards the prefetched data.

A third aspect of the present disclosure provides an electronic device, comprising a processor and a terminal that interacts with the processor, wherein the processor is configured to: perform a partitioning operation on a dataset to form a plurality of chunks; establish a data mapping mechanism based on an abstract memory space to support efficient memory management and random access; and execute a data access protocol based on opportunistic chunk selection and slot filling.

A fourth aspect of the present disclosure provides a processor, wherein the processor is configured to: perform a partitioning operation on a dataset to form a plurality of chunks; establish a data mapping mechanism based on an abstract memory space to support efficient memory management and random access; and execute a data access protocol based on opportunistic chunk selection and slot filling.

In general, compared with the existing art, the above technical solutions conceived by the present disclosure have the following beneficial effects:
(1) The present disclosure proposes a memory management method based on abstract chunk and chunk group mapping. On the premise of maintaining fully random access semantics of training data, the method is capable of implementing chunk-granularity batch data loading and memory reuse, thereby effectively improving memory access bandwidth utilization via a dynamic chunk scheduling strategy. Such a mechanism fully utilizes a characteristic of data access having “no fixed order” during a deep learning training process, avoiding a problem of existing cache replacement strategies failing in random access scenarios, thereby significantly improving loading efficiency of training data and system I/O throughput capabilities.
(2) The present disclosure further provides an opportunistic chunk selection and abstract memory slot filling algorithm. Based on a filled slot in an abstract chunk and a current memory state of a chunk group, an optimal chunk loading path is dynamically determined, ensuring that data files loaded within a chunk are maximally consumed by a training task. Without compromising random access characteristics of data, the technical solution greatly reduces invalid data loading and redundant memory storage, thereby fundamentally optimizing I/O scheduling performance in a large-scale deep learning training task.
(3) The present disclosure proposes a scalable distributed abstract memory management mechanism, constructs a logically consistent global abstract chunk address space, and performs refined control on memory access between nodes based on an ownership allocation strategy. Combined with remote opportunistic prefetching and dynamic memory release mechanisms, cross-node communication bandwidth overhead and remote I/O access latency are effectively reduced. This is particularly suitable for a distributed deep learning training scenario where a training data volume far exceeds a memory capacity of a single node, thereby implementing dual improvements in memory efficiency and training performance.

### BRIEF DESCRIPTION OF THE DRAWINGS

FIG. 1 is a flowchart of an integrated memory management method for deep learning training based on batch random access according to an embodiment of the present disclosure;

FIG. 2 is a schematic diagram of a chunk-to-abstract memory mapping mechanism according to an embodiment of the present disclosure;

FIG. 3 is a schematic diagram of a local data access protocol according to an embodiment of the present disclosure;

FIG. 4 is a schematic diagram of a distributed data access protocol according to an embodiment of the present disclosure;

FIG. 5 is a schematic diagram illustrating experimental results of training efficiency on LibriSpeech using 1 to 5 A10 nodes according to an embodiment of the present disclosure;

FIG. 6 is a schematic diagram illustrating experimental results of training efficiency on ImageNet-1k using 3 A10 nodes according to an embodiment of the present disclosure;

FIG. 7 is a schematic diagram illustrating experimental results of training efficiency on ImageNet-1k using 5 A10 nodes according to an embodiment of the present disclosure;

FIG. 8 is a schematic diagram illustrating experimental results of training efficiency on ImageNet-1k using 1 P100 node according to an embodiment of the present disclosure;

FIG. 9 is a schematic diagram illustrating experimental results of training efficiency on ImageNet-1k using 3 P100 nodes according to an embodiment of the present disclosure;

FIG. 10 is a schematic diagram illustrating experimental results of training efficiency on ImageNet-21k using 2 to 3 A100 nodes according to an embodiment of the present disclosure; and

FIG. 11 is a schematic diagram of module connections of an integrated memory management system for deep learning training based on batch random access according to an embodiment of the present disclosure.

### DETAILED DESCRIPTION OF THE EMBODIMENTS

The technical solutions of the present disclosure will be described in detail below with reference to the accompanying drawings.

Core technical terms used in the present disclosure are defined as follows:
Dataset refers to a complete original collection of data required for deep learning training, typically comprising a massive number of data instances with a scale reaching the terabyte (TB) level. In the present disclosure, the dataset serves as a logical source for chunking and random access.
Chunk refers to a logical storage unit of a fixed size formed by performing a partitioning operation on a dataset (or a random index sequence thereof). The chunk serves as a basic carrier for performing batch data loading and improving the single I/O efficiency.
Data Index Sequence refers to a sequence generated by performing a random shuffling operation on a complete dataset, which is utilized to characterize an order of data access during a training process, thereby ensuring that the access process possesses sufficient randomness semantics.
Abstract Memory Space refers to a logical hierarchical storage space composed of a plurality of abstract chunks. The abstract memory space is established on top of physical memory resources and is configured to mask the underlying physical distribution via logical mapping, thereby supporting efficient random access and reuse.
Abstract Chunk refers to a logical mapping unit to which a plurality of chunks within the same chunk group are mapped. Each abstract chunk is configured to maintain a starting address of the mapped chunk and address offsets of internal data files, supporting random access of variable-length data.
Abstract Memory Slot refers to a specific storage location or a mapping entry within an abstract chunk. A state of the abstract memory slot (e.g., empty, valid, or invalid) directly determines a logical decision for data loading and filling.
Chunk Group refers to a set formed by aggregating a plurality of chunks according to the number of abstract memory slots. The chunk group serves as a basic organizational unit for establishing a data mapping relationship, wherein one chunk group corresponds to one abstract chunk.

Data Mapping Mechanism refers to a technical means established based on the abstract memory space for establishing a correspondence between physical chunks and logical abstract chunks, so as to realize an efficient allocation of memory resources while maintaining the random access characteristics.
Opportunistic Prefetching Mechanism refers to a strategy in a distributed training scenario where an owner node infers a future trajectory (prefetch window) of a requesting node according to a globally randomized and fixed access order, and sends data in advance when conditions, such as a target slot being idle, are satisfied, so as to reduce remote I/O latency.
Ownership Allocation Strategy refers to a refined control rule for access permissions between nodes in distributed abstract memory management, ensuring that each abstract chunk is managed by a specific owner node regarding its local disk mapping, thereby maintaining the consistency of global logic.
Data File refers to a basic physical constituent unit of a dataset, typically existing in the form of a massive number of small files. Within the chunking logic, each chunk comprises a plurality of such data files, which are the target objects actually consumed by training tasks.
Valid Data refers to a state of a data file that is currently filled into an abstract memory slot and has not yet been actually consumed by a deep learning training task.
Prefetch Window refers to a subset of remote data requests that a requesting node is about to initiate within a future period of time, which is inferred by the system according to a globally fixed data access trajectory.

### Embodiment 1

The random access characteristics of deep learning training data significantly limit the optimization space for memory management schemes. Existing methods commonly adopt static caching strategies, that is, caching a portion of data in memory to accelerate access; however, data not cached still needs to be obtained through I/O operations, resulting in significant latency. Under such strategies, the proportion of data access that can be accelerated is entirely limited by memory capacity, and the physical expansion capability of memory clearly cannot match the exponential growth of training data volume. Notably, deep learning training data is typically stored in the form of a massive number of small data files, and the random access thereto generates an I/O overhead far exceeding that of large data files. To this end, large-scale analysis systems often reduce overhead by reorganizing data into larger chunk structures and implementing batch reading. However, such a scheme has a fundamental flaw in deep learning scenarios: due to the random access characteristics of the training process, when a chunk is loaded from external storage, the system cannot guarantee that a majority of data contained within the chunk can be effectively utilized before memory replacement occurs. Such uncertainty in chunk utilization makes it difficult for batch reading mechanisms to achieve the expected optimization effects in deep learning training.

To overcome the objective defects in the existing art that reference document CN116501696A only discloses a simple prefetch linked list eviction mechanism and fails to solve the problem of local invalidation when variable-length data is loaded at a chunk level, so as to implement the technical effects of effectively improving memory access bandwidth utilization and supporting precise jump addressing for variable-length data files, the present disclosure provides an integrated memory management method and system for deep learning training based on batch random access.

Preferably, a preprocessing unit 110 is configured to perform a partitioning operation on a complete dataset to form a plurality of fixed-size chunks and persist the chunks to an external storage unit 150, providing a basis for batch data loading. A mapping unit 120 is configured to group the plurality of chunks to form a plurality of chunk groups, and map the plurality of chunks within the same chunk group to the same abstract chunk in an abstract memory space. A selection unit 130, located at a core scheduling level, is configured to dynamically determine the validity of a corresponding abstract memory slot and perform a slot filling operation in response to receiving a data access request. Specifically, in a case where a distributed mode is not enabled, the selection unit 130 directly performs addressing and slot determination according to a local abstract memory. In a case of cross-node reading where the distributed mode is enabled, the selection unit 130 of a current requesting node routes a request to an owner node via a network interface component 200, and the selection unit 130 of the owner node performs addressing mapping determination. In a case of cross-node scheduling based on opportunistic prefetching, a prefetch check component 140 predicts future access items based on a prefetch window, and generates a remote data scheduling command only when a target slot of an owner node has valid data and a corresponding abstract memory slot of a requesting node is in an idle state. The remote data scheduling command is then submitted to the selection unit 130 to cooperate with the network interface component 200 to execute cross-node data exchange and loading operations with priority given to on-demand responses.

The system of the present disclosure comprises a processor 100 configured to execute the integrated memory management method based on deep learning training of the present disclosure. The present disclosure further provides an electronic device comprising a terminal and a processor 100 connected thereto. The terminal and the processor 100 interact with each other. The present disclosure further provides a storage medium configured to store an encoded program for the integrated memory management method based on deep learning training. The present disclosure further provides a processor 100 configured to run the encoded program of the method of the present disclosure. The processor 100 is configured to: perform a partitioning operation on a dataset to form a plurality of chunks; establish a data mapping mechanism based on an abstract memory space to support efficient memory management and random access; and execute a data access protocol based on opportunistic chunk selection and abstract memory slot filling.

Preferably, the physical hardware of the processor 100 may be a Central Processing Unit (CPU), a Graphics Processing Unit (GPU), an Application-Specific Integrated Circuit (ASIC/accelerator), a microcontroller (MCU), a System-on-Chip (SoC), or the like. The storage medium may be a semiconductor storage medium, a magnetic storage medium, an optical storage medium, or an emerging storage medium. The semiconductor storage medium comprises a NAND flash memory (Solid State Drive/SSD) and a Dynamic Random Access Memory (DRAM). The magnetic storage medium comprises a Hard Disk Drive (HDD) and a magnetic tape. The optical storage medium comprises a Blu-ray Disc (BDXL). An emerging storage medium is, for example, 3D XPoint (Optane Memory), Resistive Random Access Memory (ReRAM), or the like.

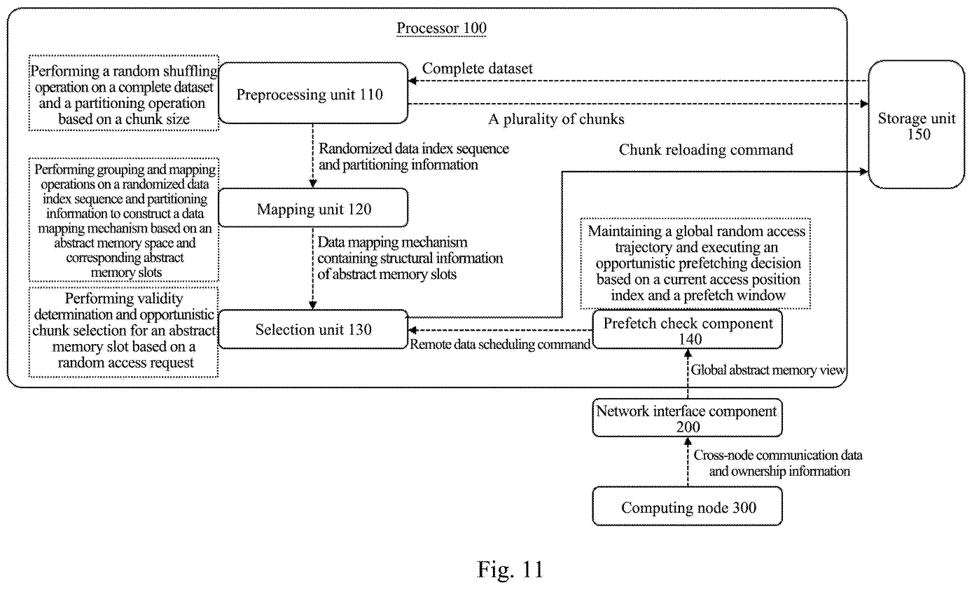

Preferably, as shown in FIG. 11, the processor 100 comprises a preprocessing unit 110, a mapping unit 120, and a selection unit 130. The preprocessing unit 110, the mapping unit 120, and the selection unit 130 cooperate with each other through data paths. Furthermore, in a distributed scenario, the system of the present disclosure further comprises a network interface component 200 configured to connect a plurality of computing nodes 300 to construct a logically consistent global abstract memory view. The global abstract memory view refers to a unified, cross-node logical memory addressing registry (or address space) constructed at a cluster level after the network interface components 200 in the cluster aggregate cross-node communication data and ownership information in a distributed deep learning training scenario. Under the global abstract memory view, all computing nodes 300 within the cluster share an identical partitioning structure of logical abstract chunks and abstract memory slots, thereby completely eliminating the isolation constraints of the physical memory in a single server.

The processor 100 further comprises the prefetch check component 140. The prefetch check component 140 is connected to the network interface component 200 and the selection unit 130, and is configured to maintain the global access trajectory and execute remote data scheduling based on opportunistic prefetching, so as to optimize cross-node I/O performance without compromising randomness.

The preprocessing unit 110 is connected to the storage unit 150 and is configured to perform a random shuffling operation on a complete dataset to generate a randomized data index sequence, and perform a partitioning operation based on a user-specified chunk size, thereby forming a plurality of chunks persisted in a storage medium.

The mapping unit 120 is connected to the preprocessing unit 110 and the storage unit 150, and is configured to perform grouping and mapping operations on the randomized data index sequence and the partitioning information, so as to construct the data mapping mechanism based on the abstract memory space and corresponding abstract memory slots. The mapping unit 120 establishes a logical space comprising a plurality of abstract memory slots based on a memory capacity and an average data size, and maps a plurality of chunks within the same chunk group to a corresponding abstract chunk.

As an execution core of the data access protocol, the selection unit 130 is connected to the mapping unit 120 and is configured to determine the validity of an abstract memory slot according to a random access request. In response to receiving a data access request, the selection unit 130 determines the abstract memory slot corresponding to a data file requested to be accessed. In response to determining that the abstract memory slot is empty or invalid, the selection unit 130 selects, from an associated chunk group based on respective fill rate of each chunk, a target chunk for reloading, and fills empty slots in the abstract chunk with the reloaded data. The selection unit 130 marks an actually consumed data file as invalid and releases, from the abstract memory space, an abstract memory slot occupied by the actually consumed data file.

Furthermore, in a distributed scenario, the system of the present disclosure further comprises the network interface component 200 configured to connect a plurality of computing nodes 300 to construct the logically consistent global abstract memory view. The processor 100 further comprises the prefetch check component 140. The prefetch check component 140 is connected to the network interface component 200 and the selection unit 130, and is configured to maintain the global access trajectory and execute remote data scheduling based on opportunistic prefetching, so as to optimize cross-node I/O performance without compromising randomness.

In a further preferred embodiment, the processor 100 is a System-on-Chip (SoC) having an Application-Specific Integrated Circuit (ASIC) design or a specialized AI accelerator, wherein the preprocessing unit 110, the mapping unit 120, the selection unit 130, and the prefetch check component 140 therein are constituted by physical hardware circuits and an on-chip connection topology as follows.

A high-speed internal data bus and a control bus based on a high-bandwidth network-on-chip are deployed within the processor 100. Each physical hardware entity is directly electrically coupled to the network-on-chip to implement mutual data output and reception. Each physical hardware entity outputs a data loading or releasing command to the external storage unit 150 via physical pins of a memory controller integrated on-chip in the processor 100, thereby establishing a high-speed serial physical connection. Meanwhile, each physical hardware entity establishes a cross-node physical electrical signal transmission path with the external network interface component 200 via a PCIe bus controller, thereby outputting a cross-node data access request to an external computing node and receiving cross-node communication data and ownership information from an external computing network.

The preprocessing unit 110 is physically implemented as a data preprocessing engine. The data preprocessing engine integrates a Direct Memory Access (DMA) control circuit and a hardware random number generation circuit. The mapping unit 120 is physically implemented as a memory management unit. The memory management unit comprises a static random access memory array and a content-addressable memory configured to enable single-clock-cycle address retrieval. The selection unit 130 is physically implemented as a scheduling coprocessor. The scheduling coprocessor comprises an arithmetic logic unit for performing ratio calculations, status registers, and a hardwired finite state machine. The prefetch check component 140 is physically implemented as a hardware prefetch engine. The hardware prefetch engine comprises a hardwired cache storing access trajectories and a hardware comparator array.

A data output end of the data preprocessing engine establishes a physical pipeline branch with a data input end of the memory management unit via a hardware first-in-first-out (FIFO) queue. A hit output pin of the memory management unit is connected to the scheduling coprocessor via a dedicated control line. The hardware prefetch engine outputs a trigger strobe pulse to the scheduling coprocessor via an interrupt request line. The processor 100 establishes serial communication links with the storage unit 150 and the network interface component 200 via on-chip integrated pins.

The data preprocessing engine performs a partitioning operation on the dataset via an internal circuit to form a plurality of chunks. Specifically, the hardware random number generation circuit executes a partitioning algorithm on the dataset, and sends the generated chunks to the DMA control circuit via a network-on-chip or a high-speed bus within the data preprocessing engine. Data within the DMA control circuit is read and invoked by the memory management unit. Meanwhile, an index sequence generated by the DMA control circuit is output to the memory management unit via the hardware first-in-first-out (FIFO) queue.

In response to receiving the sequence information, the memory management unit executes a grouping and mapping algorithm to establish a chunk-group-to-abstract-chunk mapping table in memory, groups the plurality of chunks to form a plurality of chunk groups, and maps chunks within the same chunk group to the same abstract chunk via a physical mapping mechanism, thereby constructing the logical abstract memory space. The memory management unit sends the mapping table to the scheduling coprocessor.

In response to receiving a data access request, the scheduling coprocessor queries the mapping table to automatically determine an abstract memory slot corresponding to a data file requested to be accessed. In response to determining that the abstract memory slot is empty or invalid, the scheduling coprocessor selects, from an associated chunk group, a chunk with a highest fill rate for reloading via hardware calculation; that is, the scheduling coprocessor outputs a loading command to the storage unit 150. The storage unit 150 subsequently outputs selected data content to the scheduling coprocessor. The scheduling coprocessor fills the data content into an empty slot of the abstract chunk; meanwhile, the scheduling coprocessor marks a completely consumed data file as invalid and releases memory space.

In a distributed scenario, the network interface component 200 connects the computing nodes to construct the global abstract memory view. In a cross-node scenario, the network interface component 200 outputs the received global abstract memory view to the hardware prefetch engine. The hardware prefetch engine maintains the globally randomized and fixed access trajectory and executes an opportunistic prefetching decision. In response to receiving a data access request and satisfying a prefetching prediction condition, that is, when a target slot of an owner node has data and a corresponding slot of a requesting node is idle, the hardware prefetch engine generates the remote data scheduling command and outputs the command to the scheduling coprocessor to complete a cross-node exchange.

Logical relationships among the various modules are as follows.

As shown in FIG. 11, the preprocessing unit 110 obtains the complete dataset from the storage unit 150. The preprocessing unit 110 performs the random shuffling operation on the complete dataset and the partitioning operation based on a chunk size, thereby generating a randomized data index sequence and a plurality of chunks. The preprocessing unit 110 subsequently sends the plurality of chunks to the storage unit 150 for persistent storage, and sends the randomized data index sequence and the partitioning information to the mapping unit 120.

As shown in FIG. 11, the mapping unit 120 receives the randomized data index sequence and the partitioning information from the preprocessing unit 110. The mapping unit 120 performs grouping and mapping operations on the randomized data index sequence and the partitioning information based on a system memory capacity C and an average data size d, to construct the data mapping mechanism based on the abstract memory space and the corresponding abstract memory slots. During this process, the mapping unit 120 calculates a number M of the abstract memory slots. A formula for calculating the number of abstract memory slots is: M=C/d.

The mapping unit 120 determines a size n of a chunk group in combination with a total number N of data files. A formula for calculating the size of the chunk group is: n=N/M.

After completing the construction, the mapping unit 120 sends the data mapping mechanism comprising structural information of the abstract memory slots to the selection unit 130, serving as a logical basis for executing the data access protocol.

The network interface component 200 obtains cross-node communication data and ownership information from a plurality of computing nodes 300 (forming a cluster network). The network interface component 200 performs a logical consistency view construction on the cross-node communication data and the ownership information to obtain the logically consistent global abstract memory view.

The network interface component 200 subsequently sends the global abstract memory view to the prefetch check component 140.

If a logical view and physical ownership are not distinguished, and all of the computing nodes 300 read shared storage out of order, it will trigger severe network congestion and distributed file system lock conflicts, causing training efficiency of multiple computing nodes 300 to be inferior to that of a single computing node 300. Therefore, the network interface component 200 of the present disclosure implements a unified addressing space in a multi-node cluster. A requesting party only needs to care about the abstract memory slots, while an owner party is responsible for the underlying physical I/O operations. Such a design perfectly integrates cross-node data exchange with single-machine batch loading logic, thereby achieving scalability.

The prefetch check component 140 receives the logically consistent global abstract memory view from the network interface component 200. The prefetch check component 140 maintains the globally randomized and fixed access trajectory, and executes an opportunistic prefetching decision based on a current access position index and the prefetch window. In response to receiving an access request, the prefetch check component 140 predicts future access items based on the prefetch window, and generates the remote data scheduling command only when a target slot of an owner node has data and a corresponding abstract memory slot of a requesting node is empty, so as to ensure the validity of remote data scheduling. Finally, the prefetch check component 140 sends the remote data scheduling command to the selection unit 130 to execute the cross-node data exchange.

The selection unit 130 receives the data mapping mechanism based on the abstract memory space from the mapping unit 120, and receives the remote data scheduling command from the prefetch check component 140. The selection unit 130 performs validity determination and an opportunistic chunk selection process for an abstract memory slot based on a random access request. In response to determining that the abstract memory slot is empty or invalid, the selection unit 130 calculates and selects an optimal chunk according to a principle of a highest fill rate, and generates a chunk reloading command.

The fill rate is calculated as a ratio of the number of data file slots fillable by the candidate chunk to a chunk size.

A formula for calculating the fill rate is:

$$fill\_rate = \frac{fillable\_number}{chunk\_size} .$$

In the above formula, fillable_number represents the number of data file slots fillable by the candidate chunk, that is, a fillable_number; chunk size represents the size of the chunk; and fill_rate represents the fill rate. Specifically, the size of the chunk refers to a total number of fixed file slots contained in the chunk.

Subsequently, the selection unit 130 sends the chunk reloading command to the storage unit 150 to fill the abstract memory slot, and ensures that all data files actually consumed by a training task are marked as invalid after use, to facilitate the next round of filling. Preferably, after data consumption, the selection unit 130 clears the abstract memory slot occupied by a data file marked as invalid, and releases the occupied abstract memory slot from the abstract memory space.

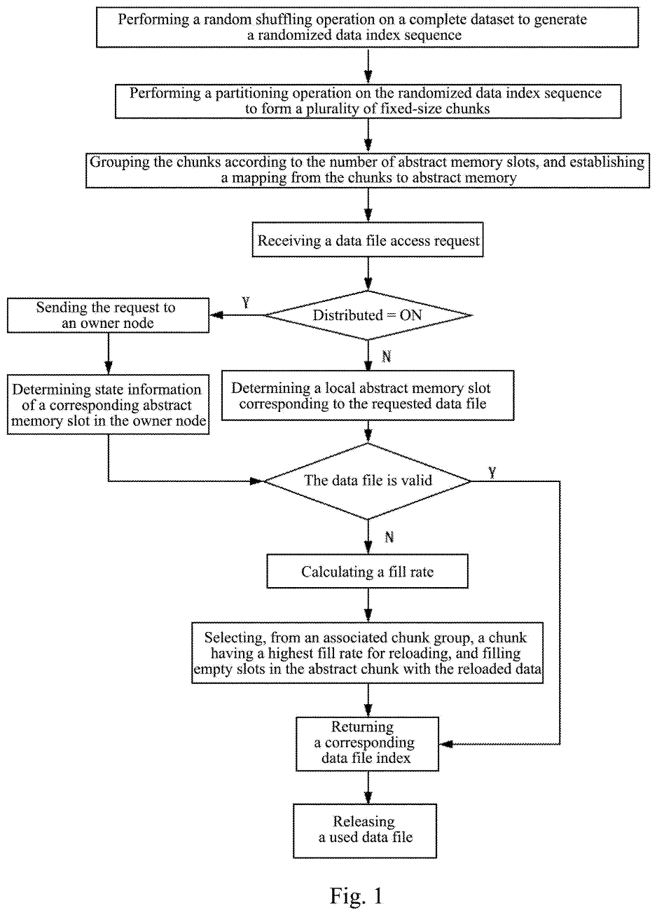

As shown in FIG. 1, a method executed by the system of the present disclosure specifically comprises the following steps:

Step S100: Chunking and preprocessing of the dataset.

The preprocessing unit 110 performs a partitioning operation on the dataset required for deep learning training to form a plurality of chunks, and sends the chunks to the storage unit 150 for external storage, providing a basis for subsequent batch data loading.

Step S110: The preprocessing unit 110 performs a random shuffling operation on the complete dataset to generate a randomized data index sequence, so as to ensure that a data access process possesses sufficient randomness semantics.

If data is simply combined for the purpose of achieving batch reading directly in an original order or without performing shuffling and solidifying operations, the random sampling characteristic required by the Stochastic Gradient Descent (SGD) algorithm in deep learning training will be compromised, causing difficulty in model convergence or a significant drop in training accuracy. Therefore, prior to performing underlying I/O batch processing, the preprocessing unit 110, from a logical source, locks and solidifies the global randomness semantics essential for deep learning training. Such a strategy of performing global shuffling first and solidifying indexes later enables the system to subsequently anticipate and manage a seemingly disordered random access trajectory.

Step S120: The preprocessing unit 110 performs a partitioning operation on the randomized data index sequence based on a user-specified chunk size to form a plurality of fixed-size chunks, each chunk comprising a plurality of data files.

Preferably, the setting of the chunk size requires a trade-off between I/O throughput and end-to-end execution efficiency: a larger chunk helps to reduce the frequency of I/O interactions (operations) and improve single-loading efficiency, but may increase the number of chunk loadings within a training epoch. The chunk size can be determined after performing a one-time system performance analysis on a target training platform.

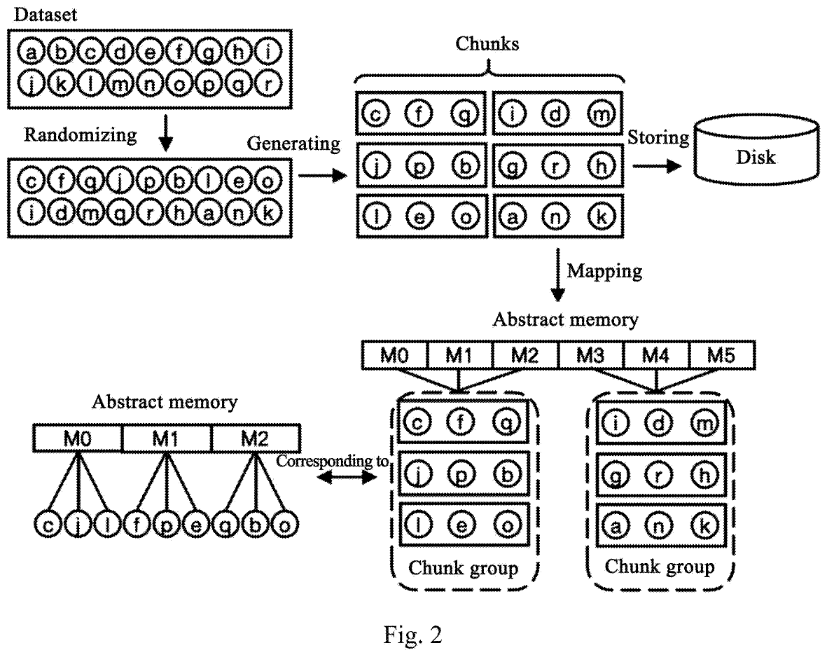

FIG. 2 illustrates a chunking process in which a total sequence length is 18 returned data files (i.e., 18 data files used in training) and a chunk size is set to 3.

The deep learning dataset comprises tens of millions of small files. If pure random access is directly performed on the small files, it will lead to a surge in disk seek time and generate catastrophic I/O overhead, which is also a root cause of computing resources waiting for data in the existing art. Therefore, the preprocessing unit 110 logically aggregates the massive, discrete, and heterogeneous small files (e.g., a single image or a single audio clip) into coarse-grained fixed-size chunks. This actually effectively transforms inefficient random I/O of the massive small files into efficient batch I/O of large files.

Step S200: Establishment of the data mapping mechanism from the chunks to an abstract memory.

After receiving the randomized data index sequence and the partitioning information from the preprocessing unit 110, the mapping unit 120 groups the chunks according to the number of abstract memory slots, and constructs the data mapping mechanism based on the abstract memory space, to support efficient memory management and random access. This specifically comprises:

Step S210: The mapping unit 120 groups the plurality of chunks according to the number of abstract memory slots to form a plurality of chunk groups.

Step S220: The mapping unit 120 maps the plurality of chunks within the same chunk group to an abstract chunk, wherein a plurality of abstract chunks collectively constitute a logical abstract memory space.

Specifically, the mapping unit 120 can roughly select the number M of the abstract memory slots by means of a memory capacity C in units of bytes and an average size d of data in the dataset, and a formula for calculating the number is: M=C/d.

Further, the mapping unit 120 can determine a size n of a chunk group according to a total number N of data files in the dataset and the number M of the abstract memory slots, and a formula for calculating the size is: n=N/M.

If a hard-coded fixed mapping ratio or a fixed memory partitioning scheme is adopted, when migrating to a scenario with a smaller GPU memory or an exponentially increasing dataset, the system is highly prone to an Out-Of-Memory (OOM) problem or an underutilization problem of physical memory, resulting in a lack of universality and engineering implementation value of the solution. Therefore, the above mapping scheme of the mapping unit 120 of the present disclosure provides an adaptive capability for dynamically decoupling software and hardware. The system can automatically scale the size of the logical abstract memory space according to actual memory resources C of a current physical machine and characteristics (N, d) of a target dataset. This enables the same set of algorithms to be seamlessly deployed on servers with different configurations and applied to tasks of different scales.

In the example shown in FIG. 2, there are a total of 2 chunk groups, each chunk group comprising 3 chunks. The chunks in a 0-th group and a 1-st group are respectively mapped to an abstract chunk (M₀, M₁, M₂) and an abstract chunk (M₃, M₄, M₅). Meanwhile, a method for forming a chunk group is illustrated, which comprises selecting n consecutive chunks to be mapped to the same abstract chunk. Another method comprises interleaving consecutive chunks across consecutive abstract chunks, similar to mapping memory addresses to memory banks in an interleaved manner. Interleaved mapping does not provide additional parallelism because data files returned by deep learning training are accessed randomly. Therefore, these two methods are functionally equivalent.

A static caching strategy in the existing art directly binds data to physical memory. When the dataset is much larger than the memory (e.g., 10 PB of data vs. 256 GB of memory), a physical cache is highly prone to invalidation, leading to a significant drop in the cache hit rate, and system performance degenerates into frequent direct disk read/write operations (I/O). The mapping unit 120 constructs a decoupled logical intermediate layer between physical memory and external storage. By establishing a (many-to-one) mapping from the chunks to the abstract chunks, the mapping unit 120 can adaptively accommodate a TB-level or even PB-level dataset according to an actual capacity of the physical memory, breaking through capacity constraints of physical memory modules.

Since the sizes of data files within a chunk vary, the mapping unit 120 controls each abstract chunk to maintain a starting address of the mapped chunk and an address offset range of each data file within the chunk, to support random access to variable-length data files.

Existing chunk-level reading optimization methods typically assume that data within a chunk are fixed-length records (e.g., a database system). If file-level offsets are not maintained, when processing media files of heterogeneous sizes, the system will be unable to perform direct jump addressing within a memory chunk, and must locate a specific file through inefficient linear scanning, which will completely negate the performance improvement brought by batch loading. The mapping unit 120 of the present disclosure successfully solves the problem of inconsistent file sizes (variable lengths) widely existing in deep learning datasets for computer vision (images), speech recognition (audio), and the like. By maintaining address offsets, the system is enabled to support file-level fine-grained precise positioning and random access after performing chunk-level coarse-grained loading.

To further make the hierarchical boundaries regarding the abstract memory space clearer, an adaptive software and hardware decoupled mapping architecture of the present disclosure adopts a logically consistent abstract memory space mechanism. When the selection unit 130 determines that a corresponding abstract memory slot is empty or invalid, dynamic scheduling calculation will be triggered to select, from an associated chunk group, a target chunk having the highest fill_rate for reloading and precisely fill the target chunk into the empty slot; when a data file pointed to by the corresponding abstract memory slot is currently valid data that has not been consumed, the selection unit 130 skips an underlying cumbersome disk reloading step, and directly returns an index of the valid data file via the shortest path, forming an ultra-fast straight-through low-latency data consumption relationship, enabling the abstract memory space to undergo completely random access reuse with physical chunks without a fixed order.

Step S300: Receiving a data file access request, and executing a data access protocol based on opportunistic chunk selection and abstract memory slot filling.

The selection unit 130, in response to random data file access requests generated during a deep learning training process, executes the following efficient data access protocol:

Step S310: When the selection unit 130 receives an access request for a certain data file, the selection unit first determines an abstract memory slot corresponding to the data file.

Specifically, as shown in FIG. 1, when the selection unit 130 receives the access request for the certain data file, the selection unit first determines whether a distributed training mode is currently enabled (i.e., determines whether Distributed=ON).

If the distributed training mode is not enabled (determined as N in FIG. 1), the selection unit 130 determines a local abstract memory slot corresponding to the requested data file.

If the distributed training mode is enabled (determined as Y in FIG. 1), the selection unit 130 of the current node sends the data access request to an owner node of a target data file via the network interface component 200, and the selection unit 130 of the owner node determines state information of a corresponding abstract memory slot in the owner node, to determine the abstract memory slot corresponding to the requested data file.

Step S320: If the selection unit 130 determines that the data file pointed to by the abstract memory slot is currently valid data, the selection unit directly returns an index of the corresponding data file, as shown in FIG. 1.

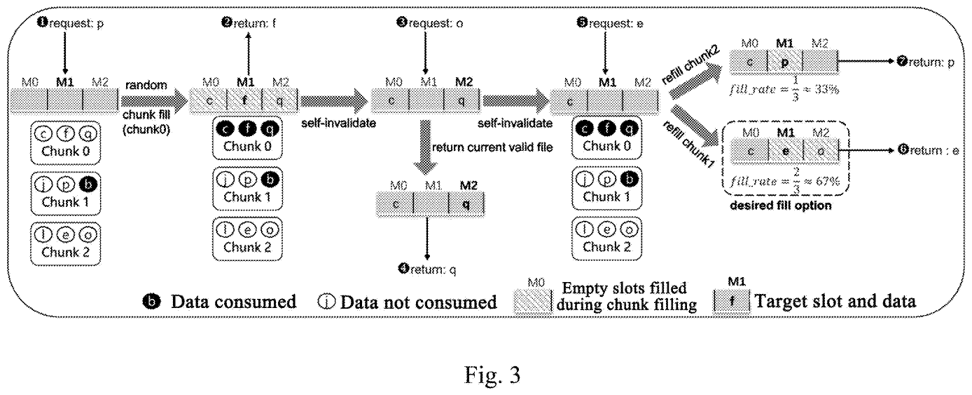

When a data file within a chunk is requested, the system may select to return any data file mapped to the same abstract memory slot within the same chunk group. As in an example shown in FIG. 3, although a data file p is mapped to Chunk 1, to process the request, the system may select to refill Chunk 0. Afterwards, the abstract chunk (M₀, M₁, M₂) is mapped to the chunk (c, f, q), and a data file f is returned. f and p are mapped into the same abstract memory slot, that is, the second data file in the group. Although the returned data file is different from the requested data file, for deep learning training, a specific data file is not important as long as the training consumes random data.

Existing operating system caching or general memory management logic must follow a strict consistency principle of “providing A when A is requested”. If this principle is adhered to, under extremely random requests of deep learning, it will inevitably lead to endless cache misses and extremely high disk I/O overhead. The selection unit 130 of the present disclosure utilizes existing, unconsumed valid data within the abstract memory slots to substitute for currently requested data, satisfies randomness requirements of algorithms with a lower system overhead, and effectively avoids unnecessary disk reloading.

Step S330: If the selection unit 130 determines that the abstract memory slot is empty or the data file is invalid, the selection unit 130 calculates a fill rate, selects the candidate chunk having the highest fill rate from the associated chunk group, generates a chunk reloading command and sends the command to the storage unit 150 to fill empty slots in the abstract chunk with the reloaded data, and then returns a corresponding data file index.

Preferably, the fill rate represents a ratio of newly filled abstract memory slots after a certain chunk is refilled and merged. Let a fillable number (fillable_number) represent the number of data file slots that can be filled via the candidate chunk, and chunk_size represent a size of the chunk.

Preferably, after determining that the candidate chunk is reloaded, the number of data files capable of being effectively filled into corresponding idle abstract memory slots is defined as the fillable number; and a ratio of the fillable number to the size of the candidate chunk is defined as the fill rate.

Specifically, a formula for calculating the fill rate (fill_rate) is:

$$fill\_rate = \frac{fillable\_number}{chunk\_size} ,$$

where fill_rate represents the fill rate.

As in the example shown in FIG. 3, after the preceding sequence of actions, only the first abstract memory slot of the abstract chunk (M₀, M₁, M₂) contains a valid data file. Considering a new request e, since it is located in the second abstract memory slot which is currently invalid, there is no way to return any data file. In this case, a new chunk should be refilled and merged with c. At this time, there are two options for refilling: Chunk 1 or Chunk 2.

If refilling Chunk 1 is selected, since a data file b in the chunk has already been consumed, only a data file p can be filled. Therefore, the fillable number is 1, and the fill rate=33%. If refilling Chunk 2 is selected, since no data file in the chunk has been consumed, the fillable number is 2, that is, remaining abstract memory slots other than the first abstract memory slot can be refilled, and the fill rate=67%. Therefore, the selection unit 130 determines that selecting to refill Chunk 2 is a preferred scheme.

If blind loading or sequential loading is adopted, the system is highly likely to load a large amount of invalid data files that have already been consumed by training. This not only wastes valuable I/O bandwidth, but also occupies scarce memory slots, causing newly loaded data to trigger a cache miss again due to being useless. To overcome this technical defect, the selection unit 130 provides a quantitative decision-making mechanism for which chunk is most cost-effective to load under pure random access. The highest fill rate means that a single I/O operation can bring the most unconsumed valid data to the memory slots, thereby maximizing disk bandwidth utilization and perfectly fitting requirements of random access.

In view of possible ambiguous understanding by those skilled in the art regarding storage structure scheduling and a dimension of the fill rate, embodiments of the present disclosure clarify an objective physical implementation logic of a processor. The processor 100 internally integrates the preprocessing unit 110, the mapping unit 120, and the selection unit 130, and interactively cooperates with the storage unit 150 externally through data paths. When executing decision-making scheduling, the selection unit 130 adopts the aforementioned ratio calculation mechanism based on the same dimension quantity, that is, a numerator of the calculation formula is the fillable number representing the number of valid files that can actually be filled currently via the candidate chunk, and a denominator is the chunk size representing a total number of fixed file slots contained in the chunk, thereby obtaining the fill rate as a quantitative indicator for evaluating a most efficient dispatching path.

Step S340: Releasing used data files.

To resist coverage pollution of expired prefetched data and maintain high-frequency reuse, the selection unit 130 ensures that all data files actually consumed by a training task are marked as invalid after use, and released from an abstract memory structure to vacate the abstract memory slots, thereby constructing a local optimal replacement underlying mechanism maintaining complete random access characteristics, for the next round of filling.

Existing systems mostly adopt LRU (Least Recently Used) or LFU (Least Frequently Used) replacement strategies. In pure random access of deep learning, data just used will absolutely not be used again within the current epoch, and strategies such as LRU would instead retain them in memory, preventing unaccessed data that is truly needed from entering memory, causing serious “cache pollution”. The selection unit 130 establishes a self-invalidation mechanism. Within each training epoch, each data file is consumed only once. Once consumption is completed, it is released immediately to make room for loading of subsequent new data, realizing high-frequency reuse of the abstract memory slots.

The example of FIG. 3 shows 2 such self-invalidation operations, after returning f and after returning q.

Further, the method can be effectively extended to a distributed scenario. In the distributed scenario comprising a plurality of computing nodes 300, each computing node 300 maintains the same view of the abstract memory space via the network interface component 200, training data is partitioned among all nodes and stored in a disk of each node, and each abstract chunk can only be mapped from a chunk stored locally in an owner node.

Specifically, when a computing node 300 accesses a data file, it first sends a request to the owner node. If the data file is valid, the owner node responds with the current data file in the corresponding abstract memory slot; otherwise, the selection unit 130 of the owner node batch-reads a chunk from the disk into the abstract chunk according to a local process, and returns a corresponding data index file.

Further, to improve cross-node data access efficiency, on the basis of the above distributed abstract memory management mechanism, the present disclosure introduces an opportunistic prefetching mechanism for reducing response latency of remote data requests and improving overall training performance.

Specifically, in a distributed training scenario comprising a plurality of participating nodes, any participating node within a cluster can dynamically act as a requesting node or an owner node according to a physical location of target data. Before training, the prefetch check component 140 generates a globally randomized and fixed data access sequence for each participating node, and replicates and distributes the sequence to all participating nodes, so that each participating node can maintain future data access trajectories of other nodes. During training, when a participating node (acting as the requesting node at this time) initiates an access request to another participating node (acting as the owner node at this time) where a target data file is located, in addition to sending an index of the target data file, a current position index in its local access sequence is also attached. The prefetch check component 140 of the owner node can thereby infer a data subset (i.e., a prefetch window) about to be requested by the requesting node within a future period of time, thereby realizing advance loading of data to be accessed.

Upon receiving the request, the owner node, on the one hand, returns the currently requested data file on demand, and on the other hand, pre-sends data files to the requesting node according to predicted access items in the prefetch window when a prefetch condition is satisfied. To ensure that prefetched data can be successfully received and cached, the requesting node performs priority processing during a receiving process according to states of the abstract memory slots: on-demand response takes priority, followed by the prefetched data. A condition for receiving the prefetched data is that the abstract memory slot mapped thereto is currently in an idle state; if the abstract memory slot has been occupied or contains valid data, the prefetched data will be discarded, to guarantee memory consistency and training accuracy.

In a complex distributed network, if all prefetched data are loaded unconditionally, it will not only easily trigger an out-of-memory problem, but also lead to overwriting of valid data (i.e., cache pollution). This situation will cause a training model to read an incorrect data sequence, severely reduce training accuracy, and even lead to abnormal termination of distributed training tasks. Therefore, the manner in which the prefetch check component 140 of the present disclosure performs priority classification ensures that data urgently needed currently is utilized fastest; such a manner (discarding the prefetched data if the abstract memory slot is occupied or contains valid data) prevents expired prefetched data caused by network latency from overwriting valid data that is currently truly useful, strictly guaranteeing correct circulation of training data.

Further, to avoid redundant transmission caused by an inability of the sending end to determine an occupancy status, during a prefetching decision process, the prefetch check component 140 of the owner node calculates an occupancy status of a target abstract chunk based on the access position index carried in the request and content of the prefetch window, in combination with the maintained global access sequence. A remote data scheduling command is generated and handed over to the selection unit 130 to execute a sending operation only when it is determined that an abstract memory slot mapped by the prefetched data is in an idle state, thereby improving effectiveness of communication overhead.

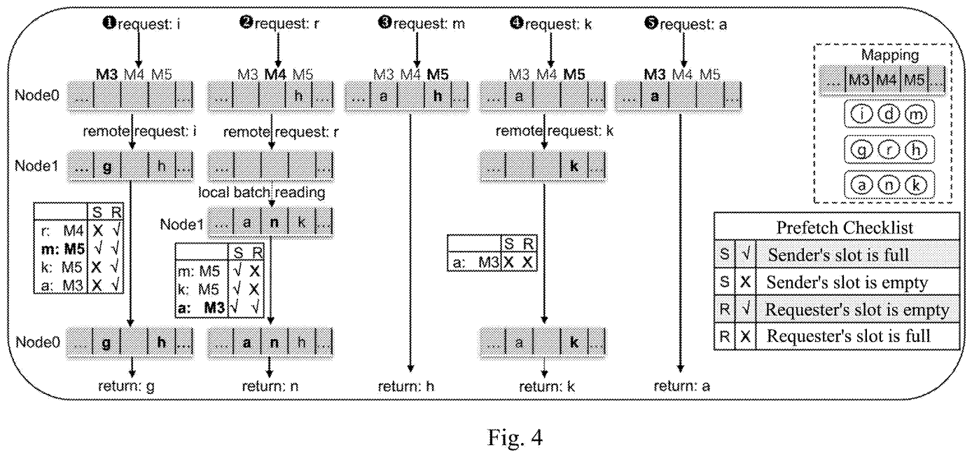

FIG. 4 illustrates a specific instance in a distributed scenario. According to a mapping relationship in the upper right corner of FIG. 4, data files i, g, and a are mapped to an abstract memory slot M₃; d, r, and n are mapped to an abstract memory slot M₄, and m, h, and k are mapped to an abstract memory slot M₅. Consider two nodes: Node 0 and Node 1, wherein Node 0 is a requester, and the current request sequence is i, followed by r, m, k, and a. It is assumed that all requests are mapped to the abstract chunks in Node 1 on the right. A prefetch checklist in the lower right corner is a key component for deciding whether to execute prefetching for a remote request, which defines a status determination logic: prefetching is performed if and only if a corresponding abstract memory slot of a sender has data, i.e., a status S is indicated as V, and a corresponding slot of a requester is empty, i.e., a status R is indicated as V. Assuming a remote request is mapped to an abstract memory slot Mᵢ, prefetching is performed only when the abstract memory slot Mᵢ of an owner node (as the sender) has data and the abstract memory slot Mᵢ of a requesting node (as the requester) is empty. Starting from a case of a miss on i, when a request from Node 0 arrives at Node 1, it is found that g is in the abstract memory slot M₃ to which i is mapped; therefore, g can be first returned as a response to Node 0, and then prefetching of r is attempted. Since r is mapped to an empty abstract memory slot M₄, no data can be returned. This is the opportunistic prefetching mechanism: if data is already in memory, the sender only provides the data instead of loading from a disk. For m, which is mapped to M₅, Node 1 finds that h is in the same abstract memory slot, i.e., Node 1 finds that h is in the abstract memory slot M₅, and the abstract memory slot M₅ of Node 0 is empty, corresponding to the status S being indicated as V and the status R being indicated as V; therefore, his sent to Node 0 as prefetched data. For k and a, which are respectively mapped to the abstract memory slot M₅ and the abstract memory slot M₃, since data h in the abstract memory slot M₅ has been extracted and allocated as prefetched data for m, and data g in the abstract memory slot M₃ has been extracted and allocated as response data for i, Node 1 has no remaining valid data in the corresponding abstract memory slots to provide, and corresponding statuses S of the sender are both indicated as X; therefore, prefetching cannot be executed for k and a. After receiving the response, Node 0 fills g and h into its abstract chunk (M₃, M₄, M₅) and returns g.

Consider the second request r. Since r was not prefetched, Node 0 sends another miss request to Node 1. At this time, since Node 1 has previously provided all remaining data to Node 0 and the abstract chunk is currently empty, it batch-reads a chunk (a, n, k) from the disk. First, n is included in a miss response for r, and then prefetching is attempted. Node 1 remembers that it has provided data for m (mapped to an abstract memory slot M₅) and continues to check k (also mapped to an abstract memory slot M₅). Since the current access to r is before m, it means that the prefetched data file m has not been consumed; even if data is available, k cannot be prefetched; otherwise, Node 0 has no place to store the data of k. However, since a is mapped to an abstract memory slot M₃ at a different location, Node 1 includes it in the prefetching. On the other hand, Node 0 receives a and n, and returns n.

Due to the data prefetched in the first step, the next access to m will hit in Node 0, and h will be returned. Next, Node 0 sends a miss request for k because it was not prefetched in the first and second steps. Node 1 does not prefetch data for a, which was already prefetched in the second step, and the data is not in memory anyway. In the last step, Node 0 will hit when accessing a, which is the previously prefetched data.

Experiments are conducted in three environments, as shown in Table 1.

TABLE 1
Data table of experimental environment settings

| | | | | | Network |
|---|---|---|---|---|---|
| GPU | Nodes | GPU/Node | CPU/Node | Memory/Node | Bandwidth |
| A10 | 5 | 1*NVDIA A10 (24 GB) | 8 Cores | 16 GB | 0.38 GB/s |
| P100 | 3 | 1*NVDIA P100 (16 GB) | 8 Cores | 60 GB | 0.38 GB/s |
| A100 | 3 | 4*NVDIA A100 (40 GB) | 48 Cores | 256 GB | 3 GB/s |

For the A10 and P100 settings, each node is equipped with dual Intel Xeon E52682 v4 4-core processors, and training data is stored on an Apsara File Storage NAS with a capacity of 10 PB. The A100 setting uses nodes equipped with dual AMD EPYC 7402 24-core processors, and training data is stored on a Lustre file system with a capacity of 2 PB. All servers run on CentOS Linux 7 (Core) with a CUDA Toolkit version of 11.2, and the experiments use PyTorch version 1.7.0.

The experiments involve two fields: Automatic Speech Recognition (ASR) and Computer Vision (CV), using 3 datasets of different sizes and 6 state-of-the-art models. For ASR, the Wav2 Vec 2.0 model is verified on the LibriSpeech dataset using the A10 setting. For CV, 5 models including SqueezeNet, MobileNetV3, ResNet50, DenseNet121, and VGG16 are used to train the ImageNet-1k and ImageNet-21k datasets.

The experiments are compared with 3 baselines. (1) PyTorch: using a native PyTorch DataLoader, relying on a caching strategy of an operating system for memory management. (2) No—I/O: based on the native PyTorch DataLoader, but replacing I/O reads by randomly simulating training data generation. This baseline does not incur any I/O costs and represents an upper bound for any optimization. (3) CoorDL: caching fixed data in memory without replacing memory, representing the state-of-the-art method without sacrificing data randomness.

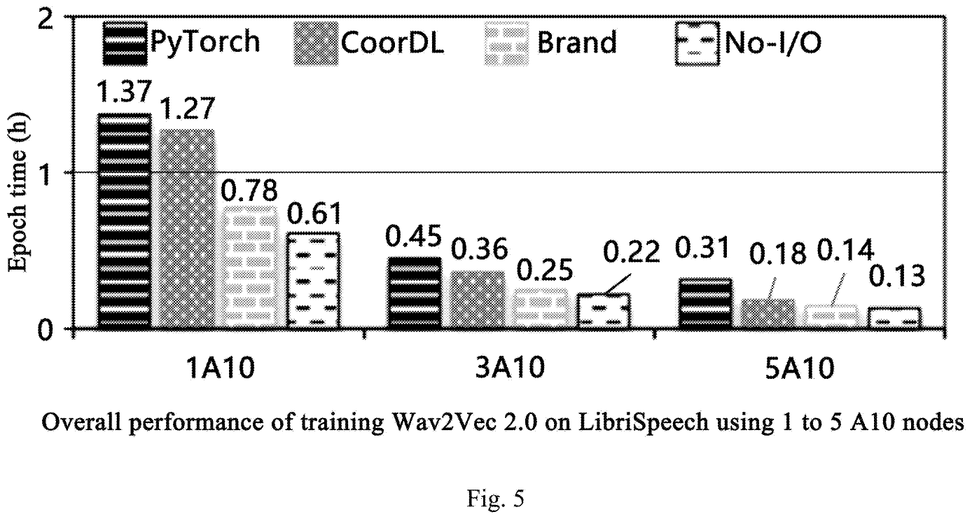

Training performance is evaluated based on a training time of each training epoch: an average training time of 5 epochs (excluding the first epoch) is calculated. All experiments utilize a maximum available memory as much as possible. Experimental results are shown in FIG. 5 to FIG. 10.

As shown in FIG. 5, when training on one node, the performance of the present method is superior to that of PyTorch, achieving a 1.77× performance improvement, and surpasses CoorDL with a speedup ratio of 1.64×. When training on three or five nodes, distributed training can realize data exchange across nodes, and the present method achieves a maximum speedup of 2.18× compared to PyTorch and is 1.46× faster than CoorDL. In particular, when training on five A10 GPUs, performance of the present disclosure (referred to as Brand in the drawings) is very close to No—I/O (a theoretical optimal value).

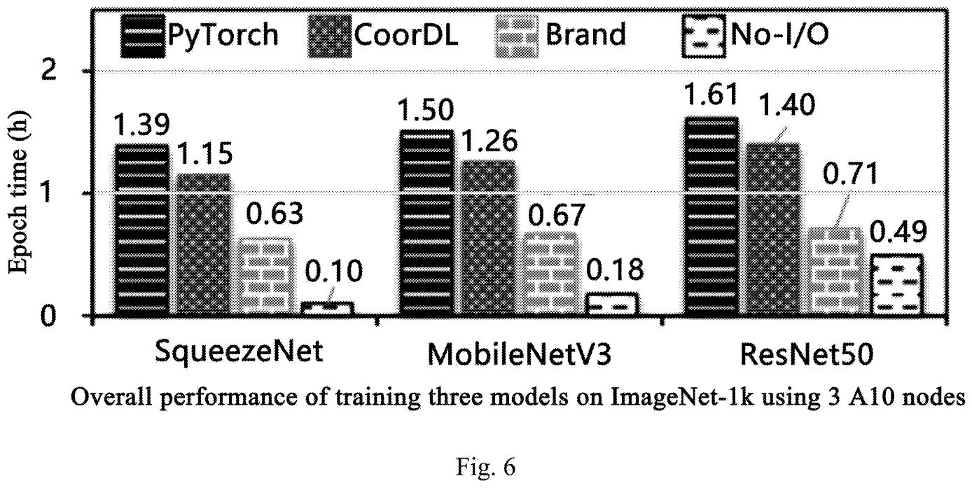

As shown in FIG. 6, the present method achieves a maximum speedup of 2.26× compared to PyTorch, and is 1.96× faster than CoorDL in this case.

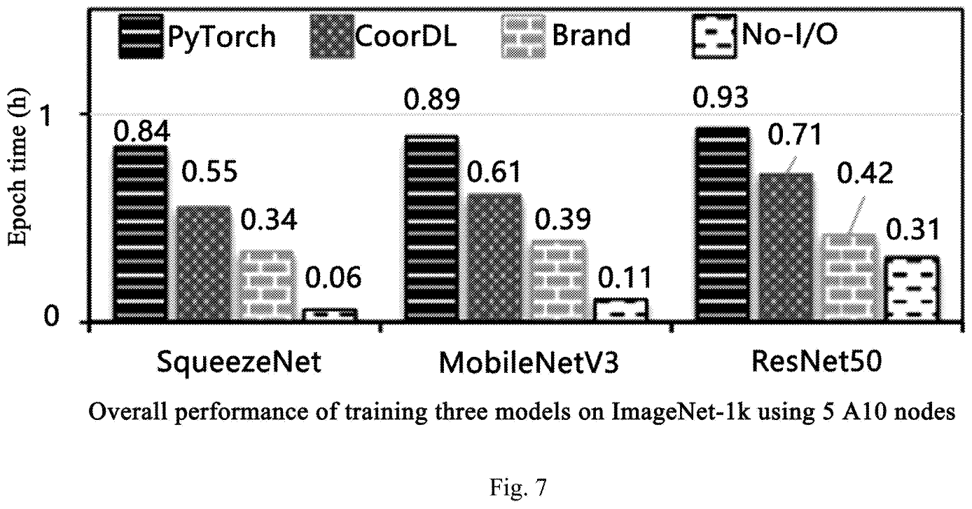

As shown in FIG. 7, when training on five A10 nodes where a global memory can cache about 40% of data, the performance of the present method outperforms PyTorch by up to 2.47× and is 1.69× faster than CoorDL.

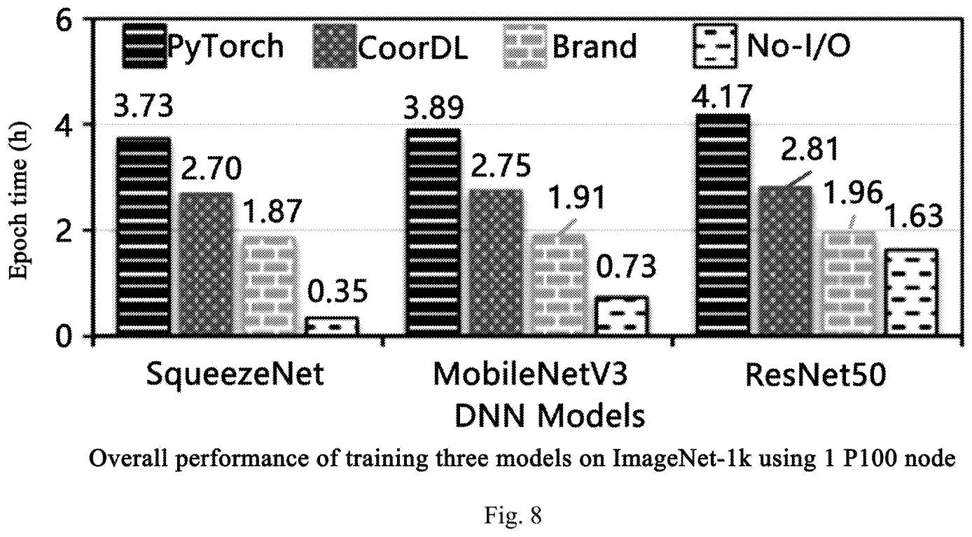

As shown in FIG. 8, when training on one P100 node without data sharing across nodes, the performance of the present method outperforms PyTorch by up to 2.13× and outperforms CoorDL by up to 1.45× in this case.

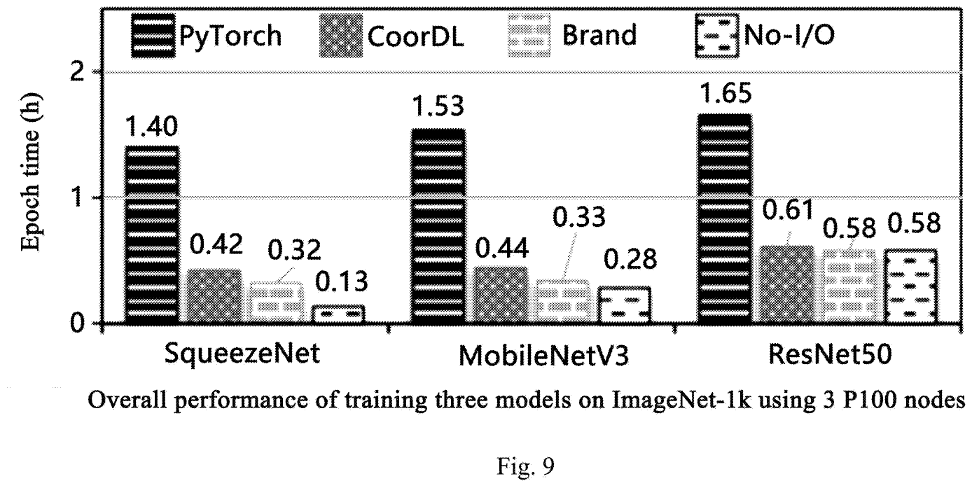

As shown in FIG. 9, when conducting experiments on three P100 nodes where the global memory can cache an entire dataset, the performance of the present method is up to 4.57× that of PyTorch, while exceeding CoorDL by 1.32× due to implementation of the prefetching mechanism.

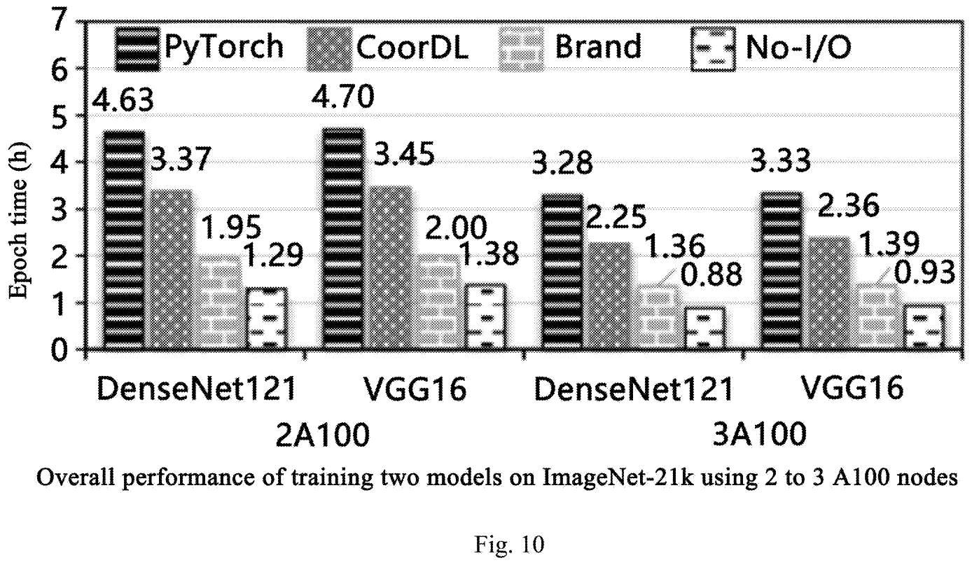

As shown in FIG. 10, when training on two A100 nodes, the present method is 2.37× faster than PyTorch and 1.73× faster than CoorDL; when training on three A100 nodes, the present method is 2.41× faster than PyTorch and 1.70× faster than CoorDL.

In the system of the present disclosure, if the opportunistic prefetching mechanism is not implemented, nodes in distributed training, upon encountering a local miss, can only synchronously wait for a network pull, resulting in idling of computing power such as a GPU. If blind prefetching is performed (without checking whether an abstract memory slot is in an idle state), prefetched data will overwrite currently useful data, causing memory conflicts or frequent data discarding, and unnecessarily increasing a network burden. The prefetch check component 140 of the present disclosure utilizes predictability provided by the random but fixed index sequence generated in the first step to asynchronously push data in advance in a distributed network, thereby masking latency of cross-node network transmission. Meanwhile, strictly enforcing a condition that a target abstract memory slot is idle ensures that the prefetched data definitively has a location to be stored.

It should be noted that the above-mentioned embodiments are exemplary. Those skilled in the art, inspired by the present disclosure, may devise various solutions within the scope and protection of the present disclosure. Furthermore, those skilled in the art will recognize that the specification and accompanying drawings provided herein are illustrative and do not constitute limitations on the appended claims. The protection scope of the present application is defined by the appended claims and their equivalents. The specification provided herein encompasses multiple inventive concepts, with terms like “preferably,” “according to a preferred embodiment,” or “optionally” indicating distinct concepts in respective paragraphs. The applicant reserves the right to file divisional applications for each inventive concept.

What is claimed is:

1. An integrated memory management method based on deep learning training, executed by a computing device configured with a storage device and a hardware accelerator, the method comprising:
performing a partitioning operation on a dataset stored in the storage device to form a plurality of chunks;
grouping the plurality of chunks to form a plurality of chunk groups, and establishing a mapping structure between a physical memory and the storage device to map chunks within the same chunk group to the same abstract chunk, such that a plurality of abstract chunks constitute a logical abstract memory space;
in response to receiving a data access request, determining an abstract memory slot corresponding to a requested data file; in response to determining that the abstract memory slot is empty or invalid, selecting, from an associated chunk group based on respective fill rates of the chunks, a target chunk for reloading, and transmitting reloaded data from the storage device and filling empty slots in the abstract chunk in the physical memory with the reloaded data; and
clearing a mapping relationship of an actually consumed data file in a mapping table to mark the actually consumed data file as invalid, and releasing a memory space occupied by the actually consumed data file.

2. The method according to claim 1, wherein the step of performing the partitioning operation on the dataset comprises:
performing a random shuffling operation on a complete dataset to generate a randomized data index sequence; and
performing a partitioning operation on the randomized data index sequence based on a set chunk size to form a plurality of fixed-size chunks, wherein each chunk comprises a plurality of data files.

3. The method according to claim 1, wherein prior to grouping the plurality of chunks to form the plurality of chunk groups, the method further comprises:
determining the number of abstract memory slots in the abstract memory space based on a memory capacity in units of bytes and an average size of data files in the dataset; and
determining a size of the chunk group based on a total number of data files in the dataset and the number of abstract memory slots.

4. The method according to claim 1, wherein after determining the abstract memory slot corresponding to the requested data file, the method further comprises:
in response to determining that a data file pointed to by the abstract memory slot is currently valid data, directly returning a corresponding data file index.

5. The method according to claim 1, wherein the step of selecting, from the associated chunk group based on the respective fill rates of the chunks, the target chunk for reloading comprises:
calculating respective fill rates of a plurality of candidate chunks in the associated chunk group; and
determining the candidate chunk having the highest fill rate among the plurality of candidate chunks as the target chunk for reloading.

6. The method according to claim 1, wherein in a distributed scenario comprising a plurality of participating nodes, the computing device is a requesting node in a distributed cluster comprising the plurality of participating nodes, and the method further comprises:
processing a remote data request based on an opportunistic prefetching mechanism;
wherein a globally randomized and fixed data access sequence is generated for each participating node;
when the participating node, acting as the requesting node, initiates an access request to another participating node acting as an owner node of a target data file, appending a current position index in a local access sequence of the participating node to the access request; and
receiving data files sent from the owner node, wherein the received data files comprise data files within a prefetch window inferred by the owner node based on the current position index.

7. The method according to claim 6, wherein in the distributed scenario comprising a plurality of participating nodes, the computing device is the requesting node in the distributed cluster comprising the plurality of participating nodes, and the method further comprises:
inferring, by the owner node, the prefetch window based on the current position index appended by the requesting node, and sending the data files within the prefetch window to the requesting node in advance when a target slot of the owner node has data and a corresponding abstract memory slot of the requesting node is empty.

8. The method according to claim 1, wherein mapping chunks within the same chunk group to the same abstract chunk comprises:
enabling each abstract chunk to maintain a starting address of the mapped chunk and an address offset range of each data file in the chunk, so as to support random access to variable-length data files.

9. The method according to claim 7, further comprising:
when the requesting node receives the data files sent from the owner node, processing the data files in order of priority, wherein an on-demand response takes priority, followed by prefetched data; and
in response to determining that an abstract memory slot mapped by the prefetched data is currently occupied or contains valid data, discarding, by the requesting node, the prefetched data.

10. An integrated memory management system based on deep learning training, comprising:
a preprocessing unit configured to perform a partitioning operation on a dataset to form a plurality of chunks;
a mapping unit configured to group the plurality of chunks to form a plurality of chunk groups, and map chunks within the same chunk group to the same abstract chunk, such that a plurality of abstract chunks constitute a logical abstract memory space; and
a selection unit configured to determine an abstract memory slot corresponding to a requested data file in response to receiving a data access request; in response to determining that the abstract memory slot is empty or invalid, select, from an associated chunk group, a chunk having a highest fill rate for reloading, and fill empty slots in the abstract chunk with the reloaded data; and mark an actually consumed data file as invalid and release, from the abstract memory space, an abstract memory slot occupied by the actually consumed data file.

11. The system according to claim 10, further comprising:
a network interface component configured to communicatively connect with a plurality of external computing nodes in a distributed training scenario to construct a logically consistent global abstract memory view; and
a prefetch check component connected to the network interface component and the selection unit, and configured to maintain a globally randomized and fixed access trajectory and execute an opportunistic prefetching decision based on a current access position index and a prefetch window;
wherein when receiving an access request, the prefetch check component predicts future access items based on the prefetch window, generates a remote data scheduling command only when a target slot of an owner node has data and a corresponding abstract memory slot of a requesting node is in an idle state, and sends the remote data scheduling command to the selection unit to execute cross-node data exchange.

12. The system according to claim 10, wherein the preprocessing unit is configured to:
perform a random shuffling operation on a complete dataset to generate a randomized data index sequence; and
perform a partitioning operation on the randomized data index sequence based on a set chunk size to form a plurality of fixed-size chunks, wherein each chunk comprises a plurality of data files.

13. The system according to claim 10, wherein the mapping unit is configured to:
determine the number of abstract memory slots in the abstract memory space based on a memory capacity in units of bytes and an average size of data files in the dataset; and
determine a size of the chunk group based on a total number of data files in the dataset and the number of abstract memory slots.

14. The system according to claim 10, wherein when mapping chunks within the same chunk group to the same abstract chunk, the mapping unit is configured to:
enable each abstract chunk to maintain a starting address of the mapped chunk and an address offset range of each data file in the chunk, so as to support random access to variable-length data files.

15. The system according to claim 10, wherein the selection unit is configured to:
after determining the abstract memory slot corresponding to the requested data file, directly return a corresponding data file index in response to determining that a data file pointed to by the abstract memory slot is currently valid data.

16. The system according to claim 15, wherein when calculating the fill rate, the selection unit is configured to:
define, as a fillable number, the number of data files that can be filled into corresponding idle abstract memory slots after a candidate chunk is reloaded; and
define the fill rate as a ratio of the fillable number to a size of the candidate chunk.

17. The system according to claim 11, wherein the network interface component is configured to:
obtain cross-node communication data and ownership information from a plurality of computing nodes; and
perform a logical consistency view construction on the cross-node communication data and the ownership information to obtain the logically consistent global abstract memory view.

18. The system according to claim 17, wherein when the requesting node receives data files sent from the owner node, the requesting node performs a receiving response for a data file serving as on-demand response data; and
for prefetched data included therein, in response to determining that an abstract memory slot mapped by the prefetched data is currently occupied or contains valid data, the requesting node discards the prefetched data.

19. The system according to claim 10, wherein the selection unit is configured to execute a self-invalidation mechanism based on deep learning training epochs:
within each training epoch, controlling each data file to be consumed by a deep learning training task only once, and immediately releasing an abstract memory slot occupied by the data file from the abstract memory space after the data file is consumed.

20. An electronic device, comprising a processor and a terminal that interacts with the processor, wherein the processor is configured to:
perform a partitioning operation on a dataset to form a plurality of chunks;
establish a data mapping mechanism based on an abstract memory space to support efficient memory management and random access; and
execute a data access protocol based on opportunistic chunk selection and slot filling.
